(19) United States
(12) Patent Application Publication
(10) Pub. No.: US 2015/0022500 A1
(43) Pub. Date: Jan. 22, 2015

(54) LIQUID CRYSTAL DISPLAY DEVICE

(71) Applicant: Panasonic Liquid Crystal Display Co., Ltd., Himeji-shi (JP)

(72) Inventors: Kazuo KITA, Osaka (JP); Genshiro KAWACHI, Osaka (JP)

(21) Appl. No.: 14/510,788

(22) Filed: Oct. 9, 2014

Related U.S. Application Data
(63) Continuation of application No. PCT/JP2013/003000, filed on May 10, 2013.

(30) Foreign Application Priority Data
May 21, 2012 (JP) 2012-115578

(51) Int. Cl. G06F 3/041; G06F 3/044

(52) U.S. Cl. CPC G06F 3/0416; G06F 3/0412; G06F 3/044
USPC 345/174; 345/87

(57) ABSTRACT

To achieve improved detection accuracy and time and position resolutions in an in-cell type capacitive touch sensor embedded in a liquid crystal panel of a liquid crystal display device, a drive electrode of the touch sensor is formed in a boundary region for separating pixel electrodes formed on a surface of a TFT substrate on a liquid crystal side, and a detection electrode is formed in a region of an opposing substrate that opposes the boundary region. A drive signal is supplied to the drive electrode to cause a voltage change, and based on the voltage change in the detection electrode caused thereby, a capacitance change in an opposing part between the drive electrode and the detection electrode is detected, to thereby detect contact of an object to a display surface near the opposing part in a liquid crystal panel.

### CROSS-REFERENCE TO RELATED APPLICATION

The present application is a Bypass Continuation of International Application No. PCT/JP2013/003000, filed on May 10, 2013, which claims priority from Japanese Patent application JP2012-115578 filed on May 21, 2012. The contents of these applications are hereby incorporated into the present application by reference in their respective entireties.

### TECHNICAL FIELD

The present invention relates to a liquid crystal display device having a touch sensor function, and more particularly, to a technology of embedding a capacitive touch sensor into a liquid crystal panel.

### BACKGROUND

In recent years, a liquid crystal display device having the following structure has been put into practical use. That is, a touch panel configured to enable a user to operate and input information by touching an image display surface with his/her finger or the like is externally mounted to a front surface side of a liquid crystal panel. Further, a structure of embedding a touch sensor function into the liquid crystal panel has also been proposed. The system of embedding the touch sensor function into the liquid crystal panel may be classified into an on-cell type and an in-cell type. In the on-cell type, a layer having a touch sensor function is formed between a polarizing plate and a glass substrate on which a color filter is formed of the liquid crystal panel. In the in-cell type, a touch sensor is formed in a thin film transistor (TFT) substrate of the liquid crystal panel during a manufacturing process for the substrate. Achieving the in-cell touch sensor function enables reduction in thickness and weight of the liquid crystal display device.

As a related-art liquid crystal display device having an in-cell touch sensor function embedded therein, there has been proposed a configuration in which, among pixel electrodes and a common electrode used for applying an electric field to liquid crystal, the common electrode doubles as a drive electrode of a capacitive touch sensor.

### SUMMARY

When an electrode used for driving a cell of the liquid crystal panel doubles as an electrode of the capacitive touch sensor, it is necessary to detect contact in a period outside an effective display period of a video signal. For example, when the contact is detected during a vertical blanking period, there arises a problem in that the time resolution in contact detection is limited by a frame rate. Further, contact at a plurality of points arrayed over a display surface is detected in a time division manner. Therefore, as the number of the points increases, time assigned to each of the points is reduced, which may reduce the accuracy of detecting capacitance change. Therefore, there has been a problem in that it is difficult to perform highly accurate contact detection with high position resolution in the relatively-short vertical blanking period.

The present invention has been made to solve the above-mentioned problems, and has an object to provide a liquid crystal display device having a touch sensor function embedded in a liquid crystal panel, which is capable of achieving improved time resolution, position resolution, and detection accuracy.

According to one embodiment of the present invention, there is provided a liquid crystal display device including: a liquid crystal panel in which liquid crystal is sandwiched between a first substrate and a second substrate arranged so as to oppose each other, the first substrate including, on a surface on the liquid crystal side thereof, a plurality of pixel electrodes arrayed two-dimensionally, which are each applied with a voltage based on a video signal, the liquid crystal display device being configured to form an image on a display surface of the liquid crystal panel by controlling alignment of the liquid crystal by an electric field generated between each of the plurality of pixel electrodes and a common electrode; and a capacitive touch sensor including: a plurality of first electrodes laminated on the surface of the first substrate on the liquid crystal side and formed in a boundary region for separating the plurality of pixel electrodes from each other; a plurality of second electrodes laminated on the second substrate and formed in a region opposing the boundary region; and a contact detection circuit configured to, when one of each of the plurality of first electrodes and each of the plurality of second electrodes is defined as a drive electrode and another thereof is defined as a detection electrode: supply a drive signal to the drive electrode to cause a voltage change; detect, based on the voltage change in the detection electrode caused by the supply, a change in capacitance in an opposing part between corresponding one of the plurality of first electrodes and corresponding one of the plurality of second electrodes; and detect contact of an object to the display surface near the opposing part.

In the liquid crystal display device according to another embodiment of the present invention, the first electrodes and the pixel electrodes are formed of a common transparent conductive film laminated on the first substrate.

In the liquid crystal display device according to yet another embodiment of the present invention, the common electrode is formed of a transparent conductive film laminated on the first substrate below the plurality of pixel electrodes.

In the liquid crystal display device according to yet another embodiment of the present invention, the opposing part between the first electrodes and the second electrodes is formed into a mesh shape along the boundary region in a region extending across a plurality of pixels.

In the liquid crystal display device according to one embodiment of the present invention, the each of the plurality of first electrodes extends in a first direction along the display surface, and the each of the plurality of second electrodes extends in a second direction different from the first direction along the display surface, and the plurality of first electrodes and the plurality of second electrodes form the opposing parts at a plurality of positions arrayed two-dimensionally in the display surface, and the contact detection circuit sequentially supplies the drive signal to a plurality of the drive electrodes to examine the voltage change in each of the detection electrodes, and determines a position at which the object is brought into contact in the display surface.

In addition, the liquid crystal display device according to one embodiment of the present invention may further include a grounded transparent electrode formed between adjacent two of the plurality of second electrodes.

In the liquid crystal display device according to one embodiment of the present invention, the contact detection circuit executes operation detecting the contact of the object in an effective display period of the video signal.

Further, it is preferred that the contact detection circuit set the drive electrode to have the same potential as a potential of the common electrode during a period in which the drive signal is not supplied.

According to one embodiment of the present invention, with the liquid crystal display device devised to achieve the in-cell touch sensor function, the contact can be detected independently of the drive of the cell of the liquid crystal panel. That is, the limitation on the contact detectable period is relaxed, with the result that improved time resolution, position resolution, and detection accuracy can be achieved in contact detection.

### BRIEF DESCRIPTION OF THE DRAWINGS

FIG. 1 is a schematic view illustrating a configuration of a liquid crystal display device according to an embodiment of the present invention.

FIG. 2 is a schematic perspective view illustrating an example of electrodes forming a touch sensor, which are formed on a TFT substrate and an opposing substrate.

FIG. 3 is a partial plan view illustrating a schematic layout of components in a display region of the TFT substrate.

FIG. 4 is a partial plan view illustrating a schematic layout of components in a display region of the opposing substrate.

FIG. 5 is a plan view schematically illustrating a part of a pattern of a drive electrode.

FIG. 6 is a plan view schematically illustrating a part of a pattern of a detection electrode.

FIG. 7 is a schematic vertical sectional view of a liquid crystal panel taken along the line VII-VII illustrated in FIGS. 3 and 4.

FIG. 8 is a schematic vertical sectional view of the liquid crystal panel taken along the line VIII-VIII illustrated in FIGS. 3 and 4.

### DETAILED DESCRIPTION

Now, a liquid crystal display device 2 that is a mode for carrying out the present invention (hereinafter referred to as “embodiment”) is described with reference to the drawings.

The liquid crystal display device 2 includes a liquid crystal panel having a capacitive touch sensor embedded therein. Description is made of the principle of contact detection (touch detection) in the capacitive touch sensor used in this embodiment. Below a display surface of the liquid crystal panel, a drive electrode and a detection electrode that are insulated from each other are laminated as electrodes for contact detection. The drive electrode and the detection electrode each have a part opposing each other, and the capacitance of the opposing part is represented by C0. The drive electrode is connected to, for example, an AC signal source configured to supply a rectangular pulse or the like, while the detection electrode is grounded via a resistor R and is also connected to a voltage detection circuit.

When an AC signal is applied to the drive electrode, a voltage change occurs in the detection electrode due to capacitive coupling. In other words, under a state in which an object such as a finger is not brought into contact with the display surface above the opposing part of the drive electrode and the detection electrode, a current corresponding to charge or discharge of the capacitance C0 flows through the resistor R, and a voltage V0 is generated in the resistor R.

On the other hand, when an object such as a finger is brought into contact with the display surface above the opposing part, a capacitance C1 is generated between the object and the detection electrode. Therefore, the voltage change in the detection electrode when an AC signal is applied to the drive electrode is smaller than the voltage V0 obtained when the object is not in contact. In other words, under a state in which an object that may be regarded as a ground potential is brought into contact, C0 and C1 are connected in series between the ground potential and the AC signal source. Under this state, as viewed from the detection electrode, a current I1 caused by charge or discharge of the capacitance C1 flows in a direction opposite to that of a current I0 caused by charge or discharge of the capacitance C0. Therefore, the current flowing through the resistor R is reduced as compared to that when the object is not in contact. As a result, a voltage V1 generated in the resistor R is smaller than V0.

The voltage detection circuit is configured to determine the difference of those voltages with use of a preset threshold value. The contact of an object can be detected based on an output signal of the voltage detection circuit.

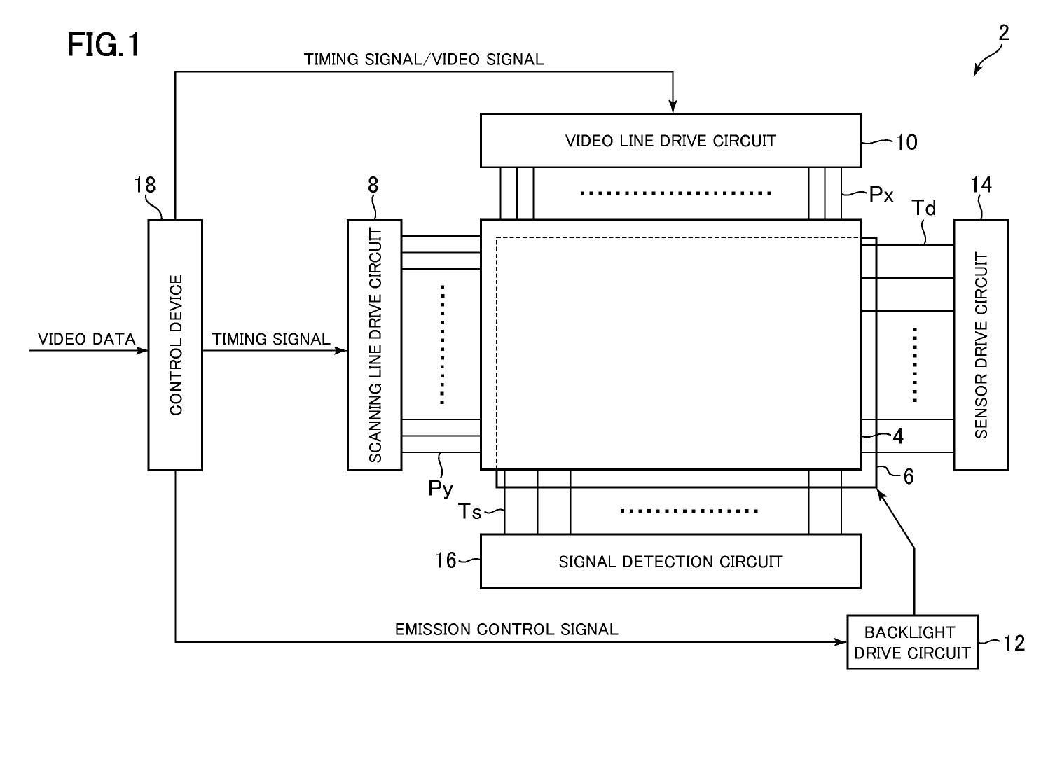

FIG. 1 is a schematic view illustrating a configuration of the liquid crystal display device 2. As illustrated in FIG. 1, the liquid crystal display device 2 includes a liquid crystal panel 4, a backlight unit 6, a scanning line drive circuit 8, a video line drive circuit 10, a backlight drive circuit 12, a sensor drive circuit 14, a signal detection circuit 16, and a control device 18.

The liquid crystal panel 4 includes a TFT substrate, an opposing substrate, liquid crystal sandwiched therebetween and the like, and has a substantially rectangular planar shape. The TFT substrate and the opposing substrate are each manufactured with use of a transparent glass substrate. The TFT substrate is positioned on the back surface side of the liquid crystal panel 4. On a surface of the glass substrate forming the TFT substrate, TFTs arranged in matrix so as to correspond to a pixel arrangement and the like are formed in a laminated manner. Further, the opposing substrate is positioned on the front surface side of the liquid crystal panel 4. A color filter (CF) and the like are formed in a laminated manner on a surface of the glass substrate forming the opposing substrate. Note that, in this embodiment, a drain and a source are defined assuming that the TFT formed in each pixel in the TFT substrate is an n-channel TFT.

In the TFT substrate, a plurality of video signal lines Px and a plurality of scanning signal lines Py are formed so as to be substantially orthogonal to each other. Each of the scanning signal lines Py is provided for each horizontal row of the TFTs, and is connected in common to gates of a plurality of TFTs in the corresponding horizontal row. Each of the video signal lines Px is provided for each vertical column of the TFTs, and is connected in common to drains of a plurality of TFTs in the corresponding vertical column. Further, a source of each TFT is connected to a pixel electrode arranged in a pixel region corresponding to the TFT.

The turning on and off of the respective TFTs is controlled on a horizontal row basis based on a scanning signal applied to the scanning signal line Py. Each of the TFTs in the horizontal row in an on state sets the pixel electrode to a potential (pixel voltage) corresponding to a video signal applied to the video signal line Px. The liquid crystal panel 4 is configured to control the alignment of the liquid crystal for each pixel region based on an electric field generated between the pixel electrode and a common electrode, and change the transmittance with respect to light entering from the backlight unit 6, to thereby form an image on the display surface.

The backlight unit 6 is disposed on the back surface side of the liquid crystal panel 4, and is configured to irradiate the back surface of the liquid crystal panel 4 with light. For example, the backlight unit 6 uses a plurality of light emitting diodes (LEDs) as a light source.

The scanning line drive circuit 8 is connected to the plurality of scanning signal lines Py formed in the TFT substrate. The scanning line drive circuit 8 is configured to sequentially select the scanning signal line Py based on a timing signal input from the control device 18, and apply a voltage for turning on the TFTs to the selected scanning signal line Py. For example, the scanning line drive circuit 8 includes a shift register. The shift register is configured to start an operation in response to a trigger signal from the control device 18, sequentially select the scanning signal line Py in order along the vertical scanning direction, and output a scanning pulse to the selected scanning signal line Py.

The video line drive circuit 10 is connected to the plurality of video signal lines Px formed in the TFT substrate. The video line drive circuit 10 is configured to apply a voltage corresponding to a video signal representing a grayscale value of each pixel to each of the TFTs connected to the selected scanning signal line Py in synchronization with the selection of the scanning signal line Py by the scanning line drive circuit 8. With this, the video signal is written into the pixel corresponding to the selected scanning signal line Py. This operation corresponds to horizontal scanning in raster graphics. By the way, the above-mentioned operation of the scanning line drive circuit 8 corresponds to vertical scanning.

The backlight drive circuit 12 causes the backlight unit 6 to emit light at a timing and brightness based on an emission control signal input from the control device 18.

In the liquid crystal panel 4, as electrodes for a touch sensor, a plurality of drive electrodes Td and a plurality of detection electrodes Ts are formed so as to be substantially orthogonal to each other. In this embodiment, the respective drive electrodes Td are formed in the TFT substrate, and are extended in a row direction (horizontal direction) of the pixel arrangement. On the other hand, the respective detection electrodes Ts are formed in the opposing substrate, and are extended in a column direction (vertical direction) of the pixel arrangement. The sensor drive circuit 14 and the signal detection circuit 16 are provided as a contact detection circuit configured to perform electric signal input and response detection between those drive electrodes and detection electrodes to detect the contact of an object to the display surface.

The sensor drive circuit 14 is the above-mentioned AC signal source, and is connected to the drive electrode group. For example, the sensor drive circuit 14 is configured to receive a timing signal from the control device 18, sequentially select the drive electrode Td in synchronization with the image display of the liquid crystal panel 4, and supply a rectangular pulse to the selected drive electrode. For example, similarly to the scanning line drive circuit 8, the sensor drive circuit 14 includes a shift register. The shift register is configured to start an operation in response to a trigger signal from the control device 18, sequentially select the drive electrode Td in order along the vertical scanning direction, and output a pulse to the selected drive electrode Td.

Note that, similarly to the scanning signal lines, the plurality of drive electrodes are extended in the horizontal direction and arrayed in the vertical direction in the TFT substrate. Therefore, it is preferred that the sensor drive circuit 14 and the scanning line drive circuit 8 be arranged along vertical sides of a rectangular region (display region) in which the pixels are arrayed. In view of this, the scanning line drive circuit 8 is disposed on one of the right and left sides, and the sensor drive circuit 14 is disposed on the other side.

The signal detection circuit 16 is the above-mentioned voltage detection circuit, and is connected to the detection electrode group. The signal detection circuit 16 may be configured to monitor the voltages of the detection electrode group in a parallel manner by providing a voltage detection circuit for each of the detection electrodes, or may be configured to monitor the voltages of the plurality of detection electrodes in a time division manner within a time period in which a pulse applied to the drive electrode is maintained by providing a single voltage detection circuit for the plurality of detection electrodes, for example.

The contact position of an object on the display surface is determined based on at which detection electrode Ts a contact voltage is detected when the pulse is applied to which drive electrode Td, and the intersection between those drive electrode Td and detection electrode Ts is calculated as a contact position. The contact position may be calculated by a circuit or an arithmetic device provided in the liquid crystal display device 2. Alternatively, information representing the detection electrode Ts from which contact voltage is detected and the drive electrode Td which is driven at this time may be output from the liquid crystal display device 2 to perform calculation processing of the contact position in an external circuit or arithmetic device.

The control device 18 includes an arithmetic processing circuit such as a central processing unit (CPU) and a memory such as a read only memory (ROM) and a random access memory (RAM). The control device 18 receives video data. For example, when the liquid crystal display device 2 constructs a display part of a computer or a mobile terminal, video data is input from the computer or the like as the main body to the liquid crystal display device 2. Further, when the liquid crystal display device 2 constructs a television set, video data is received by an antenna or tuner (not shown). The control device 18 executes various processing by controlling the CPU to read and execute a program stored in the memory. Specifically, the control device 18 is configured to subject the video data to various image signal processing such as color adjustment to generate a video signal representing a grayscale value of each pixel, and output the video signal to the video line drive circuit 10. Further, the control device 18 is configured to generate, based on the input video data, a timing signal so that the scanning line drive circuit 8, the video line drive circuit 10, the backlight drive circuit 12, the sensor drive circuit 14, and the signal detection circuit 16 may synchronize with each other, and output the timing signal to those circuits. Further, the control device 18 is configured to generate, based on the input video data, a signal for controlling the brightness of the LEDs as the emission control signal to the backlight drive circuit 12 in addition to the timing signal.

Note that, the scanning line drive circuit 8, the video line drive circuit 10, and the sensor drive circuit 14 may be formed in the TFT substrate together with the TFTs and the like in the display region. Alternatively, those circuits 8, 10, and 14 may be manufactured on a separate integrated circuit (IC), and the IC may be mounted on the TFT substrate or a flexible printed circuit (FPC) connected to the TFT substrate. Similarly, the signal detection circuit 16 may be formed in the opposing substrate or mounted on the opposing substrate or an FPC.

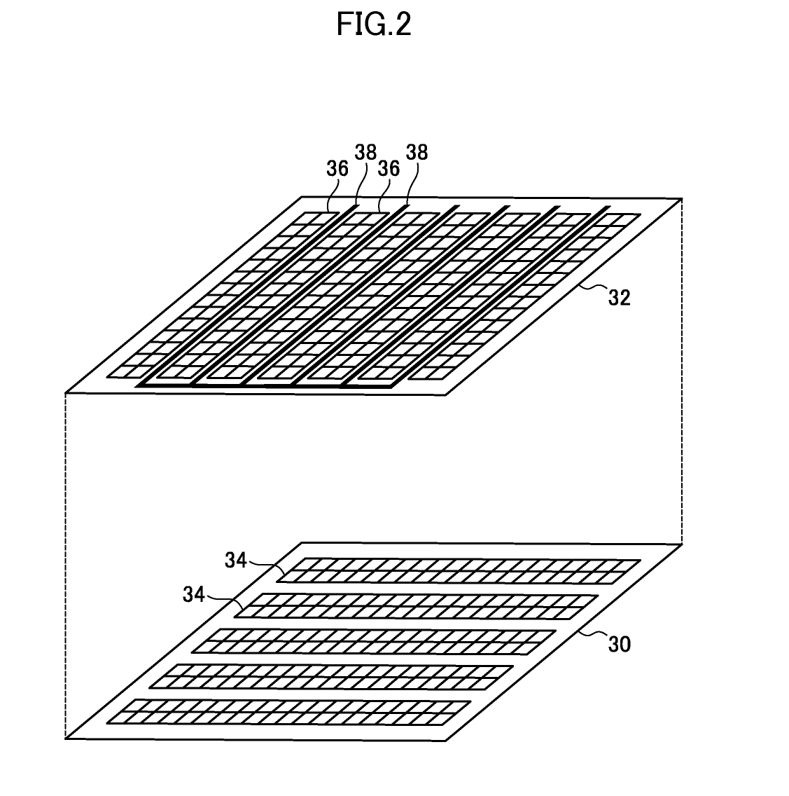

FIG. 2 is a schematic perspective view illustrating an example of electrodes forming the touch sensor, which are formed on a TFT substrate 30 and an opposing substrate 32. A drive electrode 34 and a detection electrode 36 are respectively extended in directions along the display surface, but those directions differ from each other. Specifically, in this embodiment, each of the drive electrodes 34 has an elongated shape extending in a lateral direction (horizontal direction), and the plurality of drive electrodes 34 are arrayed in a longitudinal direction (vertical direction) in the TFT substrate 30. On the other hand, each of the detection electrodes 36 has an elongated shape extending in the longitudinal direction, and the plurality of detection electrodes 36 are arrayed in the lateral direction in the opposing substrate 32. With this arrangement of both the electrodes, the drive electrodes 34 and the detection electrodes 36 form opposing parts at a plurality of positions arrayed in matrix, in other words, arrayed two-dimensionally in the display surface.

One or both of right and left ends of the drive electrode 34 are each led out from the image display region to be connected to the sensor drive circuit 14. In this embodiment, as described above, the sensor drive circuit 14 is disposed on the right side of the display region, and each of the plurality of drive electrodes 34 has its right end connected to the sensor drive circuit 14 so as to be supplied with a drive pulse.

Further, one or both of upper and lower ends of the detection electrode 36 are each led out from the image display region to be connected to the signal detection circuit 16. For example, in FIG. 1, the lower end of the detection electrode 36 is led out from the display region to be connected to the signal detection circuit 16. Note that, the detection electrode 36 is present in the opposing substrate, and hence even when the direction of leading the detection electrode 36 out from the display region is the same as that of the video signal line, the signal detection circuit 16 and the video line drive circuit 10 do not basically interfere with each other in terms of layout.

The drive electrode 34 and the detection electrode 36 are formed to have a mesh pattern composed of linear conductive members extending along a pixel boundary. This point is further described in detail later.

In the opposing substrate 32, an electrostatic shielding electrode 38 may be formed at a gap between the detection electrodes 36. An object that is brought into contact with the display surface may affect an electric field generated by the pixel electrode and the common electrode, to thereby cause color or grayscale shift in the image display at the contact position. In particular, the liquid crystal panel 4 of this embodiment employs an in-plane switching (IPS) system, and the pixel electrode and the common electrode are both formed in the TFT substrate 30. Therefore, the electric field in the liquid crystal layer may be easily disturbed by an object brought into contact on the opposing substrate 32 side. Further, the static electricity of the object may damage the TFT of the pixel. In view of this, the electrostatic shielding electrode 38 whose potential is fixed is disposed in the opposing substrate 32 so as to achieve electrostatic shielding between the liquid crystal layer and the contact object or between the TFT and the contact object. The electrostatic shielding electrode 38 is preferred to have a ground potential.

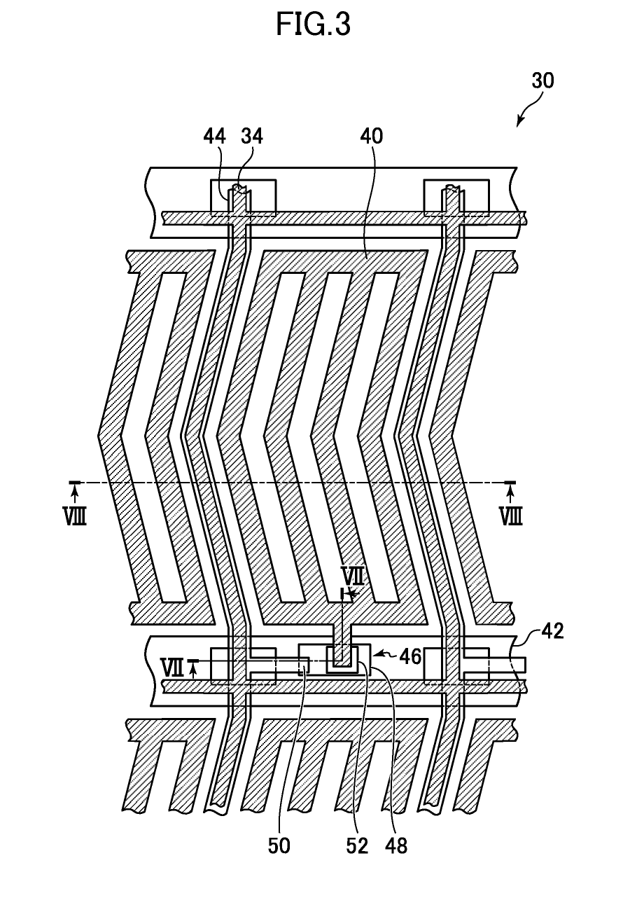

FIG. 3 is a partial plan view illustrating a schematic layout of components in the display region of the TFT substrate 30, which illustrates a state as viewed from the front surface side of the liquid crystal panel 4. In the display region, a plurality of pixels are arrayed in matrix. FIG. 3 illustrates a pixel region corresponding to one pixel and a region in its vicinity. On a surface of the glass substrate of the TFT substrate 30 on the liquid crystal side, there are laminated a pixel electrode 40, a common electrode, a gate line 42 (scanning signal line Py), a drain line 44 (video signal line Px), a TFT 46, the drive electrode 34, and the like.

The pixel region has a part (effective pixel region) through which light from the backlight unit 6 transmits. In this part, the pixel electrode 40 is disposed, which is made of a transparent conductive material such as indium tin oxide (ITO) or indium zinc oxide (IZO). In this embodiment, the common electrode made of a transparent conductive material such as ITO or IZO is formed across almost the entire display region of a layer below the pixel electrode 40. The pixel electrode 40 is formed into a shape having slits or into a comb shape so that an electric field generated between the pixel electrode and the common electrode can reach the liquid crystal in the effective pixel region.

Further, the pixel region has a boundary region surrounding the effective pixel region. The boundary region separates the pixel electrodes 40 of the adjacent pixels from each other. In this region, the gate line 42 (scanning signal line Py) and the drain line 44 (video signal line Px) are arranged, and the TFT 46 is disposed in the vicinity of the intersection of those lines. Further, in the present invention, the drive electrode 34 is disposed along the boundary region between the pixel electrodes.

The TFT 46 includes a semiconductor layer 48, and a drain electrode 50 and a source electrode 52 that are brought into Ohmic contact with the semiconductor layer 48. The drain electrode 50 is connected to the drain line 44. The source electrode 52 is connected to the pixel electrode 40 via a contact hole. The semiconductor layer 48 overlaps with the gate line 42 in a region including a gap part between the drain electrode 50 and the source electrode 52. The gate line 42 in this part functions as a gate electrode of the TFT 46.

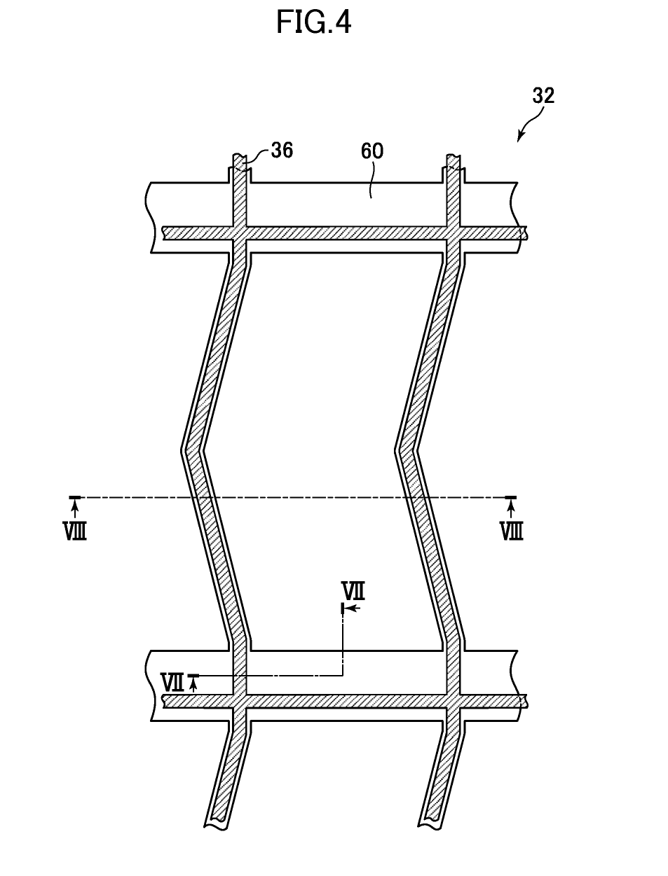

FIG. 4 is a partial plan view illustrating a schematic layout of components in the display region of the opposing substrate 32. Similarly to FIG. 3, FIG. 4 illustrates a state of the pixel region corresponding to one pixel and a region in its vicinity as viewed from the front surface side of the liquid crystal panel 4. On a surface of the glass substrate of the opposing substrate 32 on the liquid crystal side, a black matrix 60 formed of a light shielding film and the like are laminated. The black matrix 60 is formed in the boundary region surrounding the effective pixel region. On the other hand, on a surface of the glass substrate of the opposing substrate 32 on the front side, in other words, on a side opposite to the liquid crystal, the detection electrode 36 and the like are laminated. The detection electrode 36 is also disposed in the pixel boundary region.

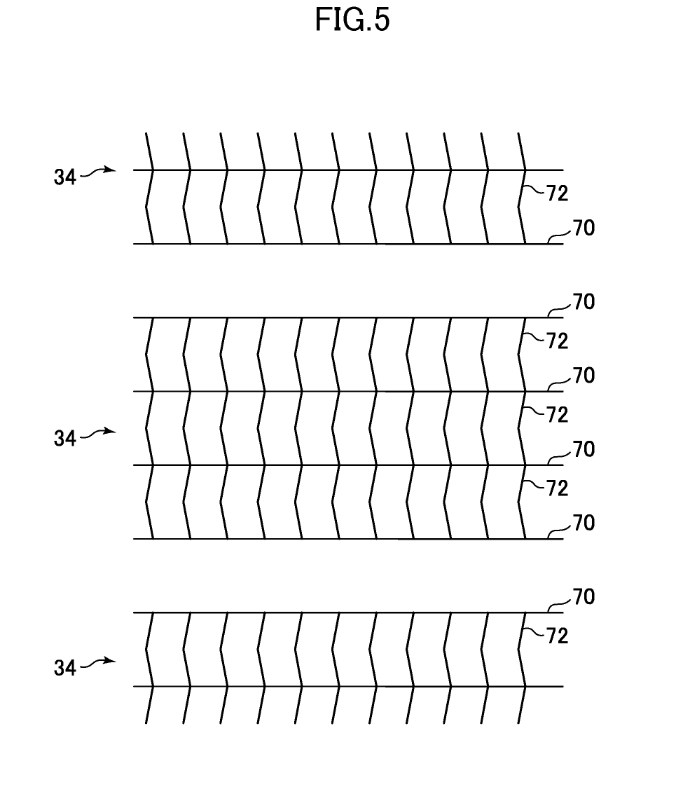

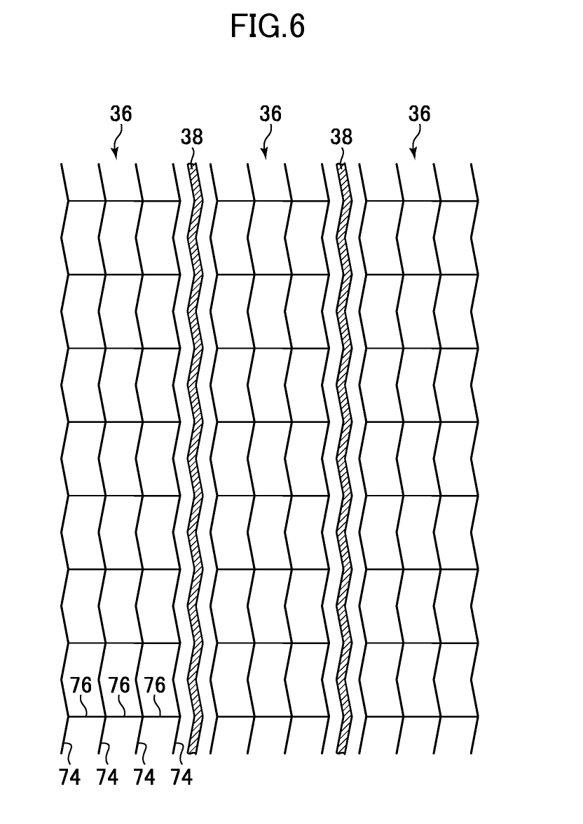

FIG. 5 is a plan view schematically illustrating a part of the pattern of the drive electrode 34, and FIG. 6 is a plan view schematically illustrating a part of the pattern of the detection electrode 36. As described above, the drive electrode 34 and the detection electrode 36 are each formed into a mesh pattern along the pixel boundary. Specifically, one drive electrode 34 has a pattern basically including a plurality of main line electrodes 70 extending so as to cross the display region in the horizontal direction, and short branch line electrodes 72 for bridging the main line electrodes 70 in the longitudinal direction. On the other hand, one detection electrode 36 has a pattern basically including a plurality of main line electrodes 74 extending so as to cross the display region in the vertical direction, and short branch line electrodes 76 for bridging the main line electrodes 74 in the lateral direction.

As described above, in order to determine the contact position in the display surface, a plurality of opposing parts between the drive electrodes 34 and the detection electrodes 36 are formed in matrix. In this case, if it is only required to form the opposing parts so as to be arrayed in matrix, one drive electrode 34 may have an electrode pattern including only one main line electrode 70, and one detection electrode 36 may have an electrode pattern including only one main line electrode 74. However, first, in the case of this electrode pattern, the area of the opposing part is small, and hence the capacitance C0 is too small, which may cause insufficiency in accuracy of detecting difference of the voltage change caused in the detection electrode 36. Second, the electrode is thin, and hence the electric resistance is increased, which may cause insufficiency in accuracy of contact detection because the rectangular pulse supplied from one end of the drive electrode 34 may be rounded or the waveform may be deteriorated before the voltage change caused in the detection electrode 36 in the opposing part reaches the end on the signal detection circuit 16 side. In view of this, as described above, one drive electrode 34 has a mesh shape in which the plurality of main line electrodes 70 are connected to each other by the branch line electrodes 72, and similarly, one detection electrode 36 has a mesh shape in which the plurality of main line electrodes 74 are connected to each other by the branch line electrodes 76. With this, the opposing part has a mesh shape that expands across a plurality of pixels, which may increase the opposing area to increase the capacitance C0. Further, the electric resistance of each electrode may be reduced.

In this embodiment, the size of each opposing part between the drive electrode 34 and the detection electrode 36 is determined based on the widths of those electrodes, in other words, the number Nd of the main line electrodes 70 included in the mesh shape of the drive electrode 34, and the number Ns of the main line electrodes 74 included in the mesh shape of the detection electrode 36. Further, the size of the opposing part determines the position resolution in the contact detection. Therefore, the numbers Nd and Ns of the main line electrodes to be bunched are determined considering a desired resolution of the contact position as well as the above-mentioned capacitance C0 and electric resistance.

Note that, image display is possible even when the mesh-shaped detection electrode 36 having an opening in the effective pixel region is not transparent, and hence a metal may be used for the detection electrode 36 to reduce the resistance.

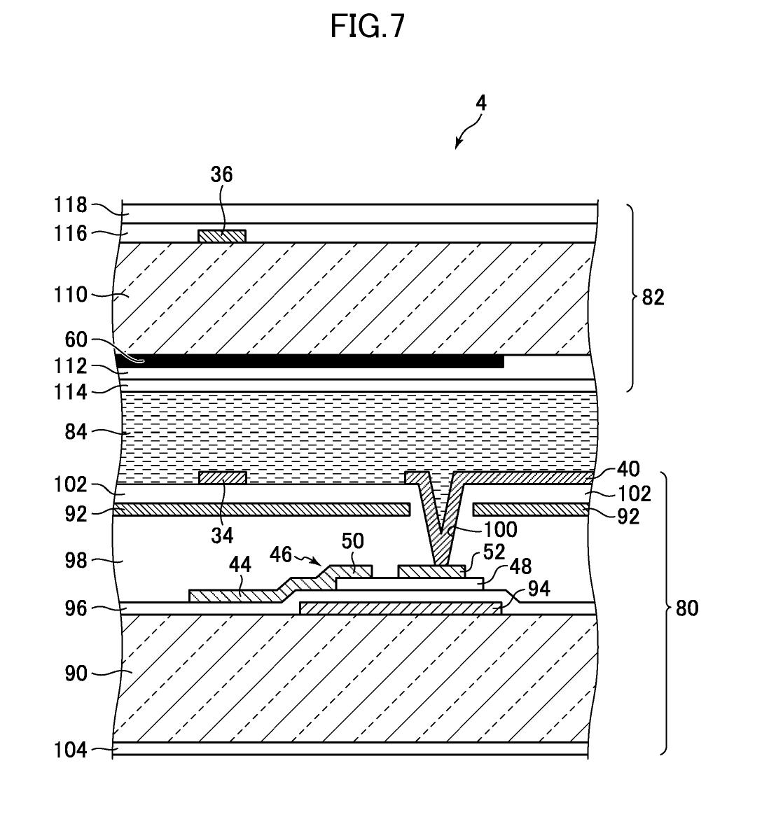

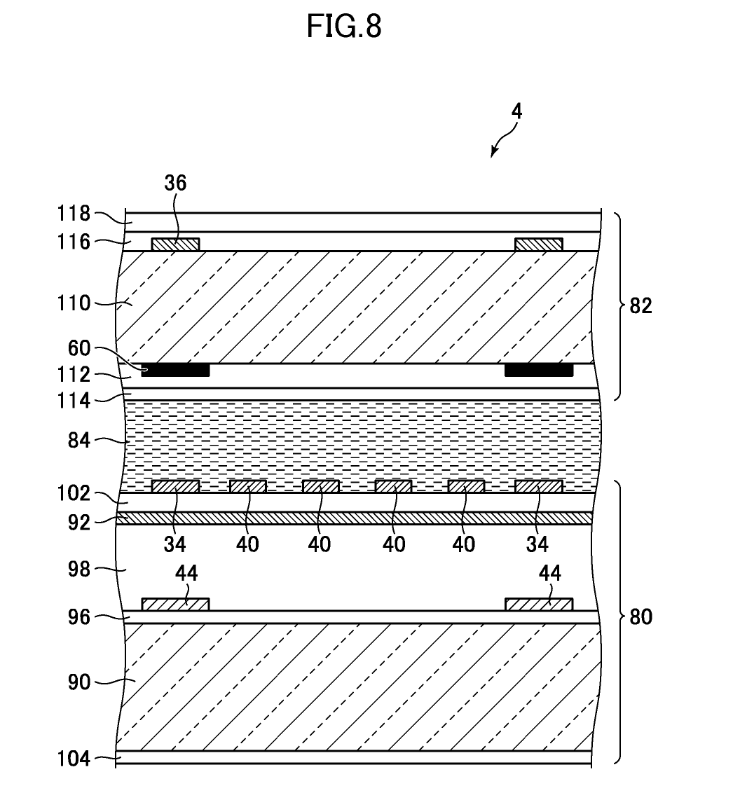

FIG. 7 is a schematic vertical sectional view of the liquid crystal panel 4 taken along the line VII-VII illustrated in FIGS. 3 and 4, and FIG. 8 is a schematic vertical sectional view of the liquid crystal panel 4 taken along the line VIII-VIII illustrated in FIGS. 3 and 4. The liquid crystal panel 4 has a structure in which liquid crystal 84 is sandwiched between a laminate 80 on the TFT substrate side and a laminate 82 on the opposing substrate side.

The laminate 80 on the TFT substrate side includes the pixel electrode 40, a common electrode 92, the TFT 46, the gate line 42, the drain line 44, the drive electrode 34, and the like, which are laminated on a surface of a glass substrate 90 on the liquid crystal 84 side. In this embodiment, the TFT 46 is an inversely staggered (bottom gate) TFT, and a gate electrode 94 is formed in a layer below a layer in which the drain electrode 50 and the source electrode 52 are formed. The gate electrode 94 is formed by patterning a metal layer laminated on the glass substrate 90 so as to be formed integrally with the gate line 42. Agate insulating film 96 made of, for example, SiO₂, SiN, or the like is formed so as to cover the gate electrode 94.

On the gate insulating film 96, the semiconductor layer 48 made of, for example, amorphous silicon or polysilicon is formed. On the semiconductor layer 48, a metal layer is laminated, which is patterned to form the drain line 44, the drain electrode 50, and the source electrode 52. The drain electrode 50 and the source electrode 52 are each formed so as to be held in contact with the semiconductor layer 48.

On the metal layer forming the drain line 44 and the like, a protective insulating layer 98 is formed, and a transparent conductive film made of ITO, IZO, or the like is further laminated thereon. This transparent conductive film is patterned to form the common electrode 92. In this embodiment, the common electrode 92 is basically disposed across the entire display region, but has an opening formed in a part that forms a contact hole 100 to the source electrode 52.

On the common electrode 92, an interlayer insulating film 102 is laminated. Above the source electrode 52, the contact hole 100 passing through the interlayer insulating film 102 and the protective insulating layer 98 is formed. Then, on the interlayer insulating film 102, a transparent conductive film similar to that of the common electrode 92 is laminated. This transparent conductive film is patterned to form the pixel electrode 40 and the drive electrode 34. The pixel electrode 40 is connected to the source electrode 52 via the contact hole 100.

On a surface of the glass substrate 90 on the back side, in other words, on a side opposite to the liquid crystal 84, a polarizing plate 104 is bonded.

The laminate 82 on the opposing substrate side includes the black matrix 60 formed of a light shielding film laminated on a surface of a glass substrate 110 on the liquid crystal 84 side. After the black matrix 60 is formed, a color filter 112 is formed, and an overcoat layer 114 made of a transparent material is further laminated thereon.

On a surface of the glass substrate 110 on the front side, in other words, on a side opposite to the liquid crystal 84, the detection electrode 36 is formed. Similarly to the drive electrode 34 or the like, the detection electrode 36 is formed of a transparent conductive film. A planarizing film 116 made of a transparent insulating material is laminated thereon, and then a polarizing plate 118 is bonded thereon.

Next, the drive of the liquid crystal panel 4 is described. As described above, the timing of image display on the liquid crystal panel 4 and the timing of touch sensor drive are controlled by the control device 18. Specifically, the control device 18 sends a trigger signal to start the operation of the shift register to the scanning line drive circuit 8 at a start timing of each frame of an image. With this, the scanning line drive circuit 8 sequentially selects the gate line 42 in a horizontal scanning period (1H), and starts an operation of outputting a scanning pulse to the selected gate line 42.

The video line drive circuit 10 receives, from the control device 18, a video signal for the selected row in synchronization with the selection of the gate line 42 by the scanning line drive circuit 8, and generates a pixel voltage corresponding to a pixel value of each pixel of the selected row to output the pixel value to the drain line 44. With this, the pixel voltage is applied to the pixel electrode 40 corresponding to the selected gate line 42.

Each pixel holds the pixel voltage applied to the pixel electrode 40 in a capacitor formed of the pixel electrode 40 and the common electrode 92. Specifically, the pixel electrode 40 is charged based on a voltage difference between the pixel voltage and the potential of the common electrode 92. Therefore, the potential of the common electrode 92 needs to be fixed in the effective display period. Therefore, in the related-art liquid crystal display device that uses the common electrode of the liquid crystal panel so as to double as the drive electrode for contact detection to achieve an in-cell touch sensor function, the contact is detected during the vertical blanking period.

In contrast, in the liquid crystal display device 2, the drive electrode 34 and the detection electrode 36 of the touch sensor are separately provided from the electrodes (common electrode 92 and pixel electrode 40) used for image display. Therefore, the operation of the touch sensor, in other words, application of a drive pulse to the drive electrode 34 and detection of voltage change in the detection electrode 36 can be basically performed independently of the operation for image display. Therefore, the liquid crystal display device 2 can detect the contact in a vertical scanning period (1V) even in the effective display period in addition to the vertical blanking period.

The effective display period occupies most of the vertical scanning period. Therefore, when the contact detection can be performed independently of the image display, first, a width of the drive pulse can be increased in scanning of sequentially applying the drive pulse to the plurality of drive electrodes 34 formed in the display region. By increasing the width of the drive pulse, it is possible to reduce the influence of waveform rounding of the drive pulse in the drive electrode 34 and the waveform rounding of a pulse induced in the detection electrode 36 on the voltage change monitored by the signal detection circuit 16. Further, it is possible to improve voltage measurement accuracy because the measuring time in the signal detection circuit 16 increases. Therefore, the accuracy in contact detection based on the voltage change in the detection electrode 36 improves. In particular, in a system in which the signal detection circuit 16 sequentially monitors the voltage changes of the plurality of detection electrodes 36 in a time division manner within each drive pulse period, increasing the width of the drive pulse is effective for improving the detection accuracy.

Further, second, performing the contact detection independently enables securing the width of the drive pulse necessary in view of detection accuracy and also increasing the scanning period of the contact detection. Thus, the time resolution in contact detection can be improved. For example, even when the scanning of sequentially applying the drive pulse to the drive electrode 34 is performed twice during the 1V period, the width of the drive pulse can be sufficiently longer as compared to the case where the scanning is performed once in the vertical blanking period. By performing the scanning for contact detection a plurality of times in the 1V period, a followable moving speed of the contact position increases.

Further, third, performing the contact detection independently enables securing the width of the drive pulse necessary in view of detection accuracy and also increasing the number of opposing parts between the drive electrodes 34 and the detection electrodes 36 formed in the display region. Thus, the position resolution in the contact detection can be improved. In inverse proportion to the increase in the number of the drive electrodes 34, the width of the drive pulse is reduced. Further, in the system in which the signal detection circuit 16 monitors the voltage changes of the plurality of detection electrodes 36 in a time division manner, as the number of the detection electrodes 36 increases, the detection time of voltage change in each detection electrode 36 reduces. However, in the present invention, the limitation on a period in which the contact can be detected is relaxed. Therefore, the number of the drive electrodes 34 and the number of the detection electrodes 36 can be increased while setting the width of the drive pulse and the detection time of the voltage change to lengths necessary for securing detection accuracy. In this manner, the number of the opposing parts can be increased. In particular, as the screen size of the liquid crystal panel 4 increases, the number of the opposing parts to be formed in the display region is required to be increased. According to the present invention, this requirement can be met easily.

Note that, in this embodiment, the common electrode 92 electrically shields a part between the drive electrode 34 and the gate line 42 and a part between the drive electrode 34 and the drain line 44. Therefore, the influence of the drive of the touch sensor on the display operation of the liquid crystal panel 4, and reversely the influence of the display operation of the liquid crystal panel 4 on the operation of the touch sensor are reduced.

During a period in which no drive pulse is applied to the drive electrode 34, in order to prevent deterioration in image quality caused by ionic impurities in liquid crystal being accumulated to the vicinities of the electrodes due to application of a DC voltage to the liquid crystal 84, it is preferred to set the drive electrode 34 to have the same potential as potential of the common electrode 92.

### Modified Examples

The liquid crystal display device according to the present invention can be configured differently from that described in the embodiment above. In the following, the other configurations are described. Note that, components similar to those in the above-mentioned embodiment are denoted by the same reference symbols. Description of common matters is basically omitted, and differences from the above-mentioned embodiment are mainly described. Note that, the configurations below are part of modified examples of the liquid crystal display device according to the present invention, and the present invention is not limited to the embodiment described above and the modified examples described below.

(1) The detection electrode 36 may be disposed on the surface of the opposing substrate 32 on the liquid crystal 84 side.

(2) The extending direction of the drive electrode 34 and the extending direction of the detection electrode 36 may be exchanged. That is, the drive electrode 34 may be extended in the lateral direction, and the detection electrode 36 may be extended in the longitudinal direction.

(3) The drive electrode 34 may be disposed on the opposing substrate 32 side, and the detection electrode 36 may be disposed on the TFT substrate 30 side. In this configuration, the capacitance between the detection electrode 36 and the common electrode 92 increases, and hence the difference in voltage change in the detection electrode 36 between when the object is brought into contact and when the object is not brought into contact is reduced as compared to the case of the above-mentioned embodiment. However, as described above, the detection accuracy is improved by increasing the detection time of voltage change, and hence contact detection is possible also with this configuration. Note that, also in this configuration, the detection electrode 36 and the drive electrode 34 may be extended in the lateral direction and the longitudinal direction, respectively, or the detection electrode 36 and the drive electrode 34 may be extended in the longitudinal direction and the lateral direction, respectively. Further, the drive electrode 34 disposed on the opposing substrate 32 side may be disposed on the surface of the opposing substrate 32 on the liquid crystal 84 side.

(4) Image display is possible even when the detection electrode 36 formed of the transparent conductive film in the opposing substrate 32 is disposed in the effective pixel region. In other words, the opposing substrate 32 may be disposed in any one of the effective pixel region and the pixel boundary region. Therefore, the detection electrode 36 may be formed into, for example, a stripe shape thicker than the pixel boundary region instead of the above-mentioned mesh shape so as to be disposed in the effective pixel region. In such a configuration, the coupling capacitance between the detection electrode 36 and the common electrode 92 increases, and hence the voltage change caused in the detection electrode 36 may reduce. However, according to the present invention, as described above, the detection accuracy is improved by increasing the detection time of voltage change, and hence contact detection is possible also with this configuration.

(5) In the above-mentioned embodiment, the liquid crystal display device 2 includes the liquid crystal panel 4 employing the IPS system with a structure in which the pixel electrode 40 is laminated above the common electrode 92 (hereinafter referred to as “STOP structure”). The present invention is also applicable to a liquid crystal display device using a liquid crystal panel employing other systems. Specifically, the liquid crystal panel 4 may employ an IPS system with a structure in which the common electrode 92 is laminated above the pixel electrode 40 (hereinafter referred to as “CTOP structure”). Further, other systems may be employed such as a vertical alignment (VA) system in which the pixel electrode 40 is disposed in the TFT substrate 30 and the common electrode 92 is disposed in the opposing substrate 32. In the liquid crystal panel 4 employing the IPS system with the CTOP structure or the liquid crystal panel 4 employing a system other than the IPS, a layer of the common electrode 92 may exist between the drive electrode 34 and the detection electrode 36, but contact detection is possible by forming an opening in the common electrode 92 at the opposing part between the drive electrode 34 and the detection electrode 36 so as to cause capacitive coupling between the drive electrode 34 and the detection electrode 36.

Further, in the liquid crystal panel 4 employing the IPS system with the CTOP structure, the drive electrode 34 (or the detection electrode 36) may be formed in a layer different from that of the pixel electrode 40. That is, a conductive film different from the conductive film laminated below the common electrode 92 to form the pixel electrode 40 may be laminated above the common electrode 92, and this conductive film may be used to form the drive electrode 34 (or the detection electrode 36) in the pixel boundary region of the TFT substrate 30.

(6) In the liquid crystal panel 4 employing the IPS system with the STOP structure, by forming the drive electrode 34 and the pixel electrode 40 from a common conductive film as in the above-mentioned embodiment, there are advantages in that the increase in the number of steps and misalignment in the manufacturing process can be prevented. When those advantages are not required to be considered, in the liquid crystal panel 4 employing the IPS system with the STOP structure, the drive electrode 34 (or the detection electrode 36) may be formed of a conductive film different from that of the pixel electrode 40. With this, for example, the drive electrode 34 (or the detection electrode 36) that does not need to be transparent because the electrode is disposed in the pixel boundary region may be made of a metal in the TFT substrate 30 so as to reduce the resistance as compared to the case where the electrode is formed of the same transparent conductive film as the pixel electrode 40.

(7) In the above-mentioned embodiment, both of the drive electrode 34 and the detection electrode 36 are formed as a plurality of mesh electrodes that extend so as to intersect to each other, but the present invention is not limited thereto. For example, the drive electrode 34 may be formed as a single mesh electrode extending across the entire effective display region of the liquid crystal panel 4, and the detection electrode 36 may be formed as a plurality of mesh electrodes arrayed in matrix. Alternatively, the drive electrode 34 may be formed as a plurality of mesh electrodes divided into stripes as in the above-mentioned embodiment, and the detection electrode 36 may be formed as a plurality of mesh electrodes arrayed in matrix as described above. In those configurations, the detection electrode 36 is an individual electrode for each opposing part, and a signal line is led out for each opposing part from the detection electrode 36 to the signal detection circuit 16.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a liquid crystal panel in which liquid crystal is sandwiched between a first substrate and a second substrate arranged so as to oppose each other, the first substrate including, on a surface on the liquid crystal side thereof, a plurality of pixel electrodes arrayed two-dimensionally, which are each applied with a voltage based on a video signal,
the liquid crystal display device being configured to form an image on a display surface of the liquid crystal panel by controlling alignment of the liquid crystal by an electric field generated between each of the plurality of pixel electrodes and a common electrode; and
a capacitive touch sensor comprising:
a plurality of first electrodes laminated on the surface of the first substrate on the liquid crystal side and formed in a boundary region for separating the plurality of pixel electrodes from each other;
a plurality of second electrodes laminated on the second substrate and formed in a region opposing the boundary region; and
a contact detection circuit configured to, when one of each of the plurality of first electrodes and each of the plurality of second electrodes is defined as a drive electrode and another thereof is defined as a detection electrode:
supply a drive signal to the drive electrode to cause a voltage change;
detect, based on the voltage change in the detection electrode caused by the supply, a change in capacitance in an opposing part between corresponding one of the plurality of first electrodes and corresponding one of the plurality of second electrodes; and
detect contact of an object to the display surface near the opposing part.

2. The liquid crystal display device according to claim 1,
wherein the first electrodes and the pixel electrodes are formed of a common transparent conductive film laminated on the first substrate.

3. The liquid crystal display device according to claim 2,
wherein the common electrode is formed of a transparent conductive film laminated on the first substrate below the pixel electrodes.

4. The liquid crystal display device according to claim 1,
wherein the opposing part between the first electrodes and the second electrodes is formed into a mesh shape along the boundary region in a region extending across a plurality of pixels.

5. The liquid crystal display device according to claim 4,
wherein the each of the plurality of first electrodes extends in a first direction along the display surface, the each of the plurality of second electrodes extends in a second direction different from the first direction along the display surface, and the plurality of first electrodes and the plurality of second electrodes form the opposing parts at a plurality of positions arrayed two-dimensionally in the display surface, and
wherein the contact detection circuit sequentially supplies the drive signal to a plurality of the drive electrodes to examine the voltage change in each of the detection electrodes, and determines a position at which the object is brought into contact in the display surface.

6. The liquid crystal display device according to claim 5, further comprising:
a grounded transparent electrode formed between adjacent two of the plurality of second electrodes.

7. The liquid crystal display device according to claim 1,
wherein the contact detection circuit executes operation detecting the contact of the object in an effective display period of the video signal.

8. The liquid crystal display device according to claim 1,
wherein the contact detection circuit sets the drive electrode to have the same potential as a potential of the common electrode during a period in which the drive signal is not supplied.
